(19) United States
(12) Patent Application Publication
(10) Pub. No.: US 2025/0216839 A1
(43) Pub. Date: Jul. 3, 2025

(54) Operating Method and Control System Capable of Collaboration for a Technical Installation

(71) Applicant: Siemens Aktiengesellschaft, Muenchen (DE)

(72) Inventor: Benjamin LUTZ, Pfinztal (DE)

(21) Appl. No.: 18/852,552

(22) PCT Filed: Mar. 1, 2023
(86) PCT No.: PCT/EP2023/055102

§ 371 Date: Sep. 30, 2024

(30) Foreign Application Priority Data
Mar. 31, 2022 (EP) 22165938.6

(51) Int. Cl. G05B 19/418

(52) U.S. Cl. CPC G05B 19/41865; G05B 19/41885

(57) ABSTRACT

A control system for a technical installation, wherein an operator station server transmits visualization information to an operator station client and the operator station client generates a visualization for an operator of the technical installation based on the visualization information, where the control system captures, at at least one first point in time, when instigated by a first operator, a state of the visualization of an installation state generated at this point in time by the first operator station client and stores it in a first memory such that inputs by the first operator are also captured and stored for generating the state of the visualization, and the control system receives from the first operator, via the first operator station client, information about at least one second operator as the receiver for the stored state of the visualization and assigns the state of the visualization to this second operator.

### CROSS-REFERENCE TO RELATED APPLICATIONS

This is a U.S. national stage of application No. PCT/EP2023/055102 filed 1 Mar. 2023. Priority is claimed on European Application No. 22165938.6 filed 31 Mar. 2022, the content of which is incorporated herein by reference in its entirety.

### BACKGROUND OF THE INVENTION

### 1. Field of the Invention

The invention relates to a control system for a technical installation, in particular a production or processing installation and also relates to a method for operating the control system of the technical installation.

### 2. Description of the Related Art

For the operation and observation of large technical installations, for example, for production or processing installations, operators (i.e., persons for operating and observing the installation) are offered dynamic installation images and various graphical views of trend sequences, alarm sequences or states of process objects. In installation images, operators can open further windows for the analysis or input of setpoint values, such as faceplates, progress indicators for measurement values and alarm output indicators. Depending upon the activity, an operator can have a large number of windows open and simultaneously also undertake a plurality of inputs.

EP 3 876 046 A1 discloses a control system of a technical installation that enables an adaptation, by an operator during a runtime of the technical installation, of a presentation of visualization information made by an operator station client. For example, the operator can undertake changes or adaptations on an installation image, i.e., a graphical representation of the installation or of its components in that he selects trend indications and/or notification sequences. Such a change is designated a “user selection”. The change is passed on to an engineering station server to make it available to a project engineer for the engineering of the installation.

From EP 3 637 205 A1 or WO 2020/074653 A1, a control system of a technical installation is known in which by a first operator of a first operator station client who is connected to an operator station server, predetermined operating information regarding the runtime of the technical installation is deposited in a memory store such that it can be retrieved and used for the configuration of an image display for a second operator of a second operator station client. The operating information can be, for example, compilations that the first operator has undertaken via the first operator station client. A compilation should be understood, for example, as a collection of trends and installation images that can be opened again and again as a “predefined” selection. The operating information can also be installation images of the technical installation.

As a consequence of the operating information deposited by the first operator in the memory store, the second operator is notified, in particular, via a graphical indication on the image display of the second operator station client used by him, of a proposal by the first operator to display the installation images of the first operator on the image display of the second operator station client. The second operator can therein open just one installation image on the second operator station client, regarding which he has a corresponding authorization.

### SUMMARY OF THE INVENTION

Proceeding therefrom, it is an object of the invention to provide a control system for a technical installation that permits a yet further improved cooperation between operators in the operation and observation of the technical installation.

This and other objects and advantages are achieved in accordance with the invention by a control system for a technical installation and by a method for operating the control system of the technical installation, where the control system in accordance with the invention comprises at least one operator station server and at least one operator station client connected to the operator station server. Therein, the operator station server is configured to transfer visualization information to the operator station client. The operator station client is configured, based on the visualization information, to create a visualization for an operator of the technical installation.

The control system in accordance with the invention is configured, during the runtime of the technical installation, at the instigation of a first operator, at at least one first time point, to acquire a current state of the visualization of an installation state that is generated at this time point by a first of the operator station clients and to deposit it in a, preferably non-volatile, first memory store. The acquisition of the state of the visualization therein comprises an acquisition of inputs by the first operator for generating the current state of the visualization and the storage of the state comprises a storage of the acquired inputs.

The control system is therein configured to receive from the first operator, via the first operator station client, an information item regarding at least one second operator as the recipient for the deposited state of the visualization and thereby to assign the state of the visualization deposited in the memory store to this second operator.

The memory store can therein be a memory store of the control system or a cloud-based memory store outside the control system. Preferably, the memory store is therein a storage region of an operator station server of the control system. If the control system comprises a plurality of operator station servers, each with a storage region for depositing states of visualizations, then the storage regions are advantageously replicated with one another. An operator or operator station client then has, notwithstanding at which operator station server he registers, access to all the states of visualizations that are passed on to him.

The technical installation can be an installation of the processing industry, such as a chemical, pharmaceutical, petrochemical installation or an installation of the food and luxury produce industry. Included thereby are also any technical installations of the production industry, factories in which, for example, automobiles or goods of any kind are produced. The technical installations can also belong to the field of energy production. Wind turbines, solar installations or power stations for energy generation are also included under the expression technical installation.

A control system should be understood in the present context to be a computer-supported technical system that comprises functionalities for representing, operating and controlling the process engineering installation. The control system can also comprise sensors for determining measurement values and different actuators. In addition, the control system can comprise closely process-related or closely production-related components that serve for controlling the actuators or sensors. Furthermore, the control system has, inter alia, means for visualization of the technical installation and for engineering. The control system can optionally also comprise further computing units for more complex regulation operations and systems for the storage and processing of data.

An “operator station server” should be understood herein to be a server that centrally acquires data from an operating and observation system and, typically, archives of alarm and measurement values of a control system of a technical installation and makes it available to users. The operator station server typically creates a communication connection to automation systems of the technical installation and passes on data from the technical installation for visualization to “operator station clients” that serve to run and observe an operation of the individual functional elements of the technical installation. The operator station server can have client functions available in order to gain access to the data (archives, notifications, tags, variables) from other operator station servers.

By this means, images of an operation of the technical installation on the operator station server can be combined with variables of other operator station servers (server-server communication). The operator station server can be, though without being restricted thereto, a SIMATIC PCS 7 industrial workstation server from the SIEMENS company.

An operator of the technical installation can access the operator station server via the operator station client which can be, for example, a tablet, a smartphone, a personal computer, a computer with a large-scale display in a control room or suchlike, for the purpose of operating and observing the technical installation on the operator station server.

Here, a visualization should be understood to be the graphical presentation that occurs via the operator station client for the operator. Typically, the operator station client has corresponding functionalities, relevant visualization information that he receives from the operator station server to create the intended visualization.

Therein, the visualization in general can comprise, in a per se known manner, a graphical reproduction of an installation image of the technical installation, graphical windows with progress indicators of measurement values (for example, trend indications) from the technical installation, notification indications, graphical objects that represent the technical objects of the technical installation, text fields for inputs by the operator, such as setpoint values of a regulator and suchlike. In the case of a processing installation, the installation image can comprise, for example, graphical representations of pumps, valves, tanks, pipelines, combustion chambers or suchlike. The graphical representations can therein comprise current process measurement values, status values, (alarm) notifications or suchlike.

The visualization therein visualizes an actually existing installation state in the installation at a particular time point, i.e., values of process variables, setpoint values, regulation variables, measurement values, alarms, flow rates, fill levels, operator inputs, etc., prevailing in the installation at a particular time point.

The first operator can determine, through input, the graphical objects, their arrangement and position to one another, their size and contents and bring them to notice. Depending upon the activity and the current operation and observation task, an operator can have a large number of windows open and simultaneously also make a plurality of inputs.

The control system in accordance with the invention is configured, at the runtime of the technical installation, that is, during an operation of the technical installation, at at least a first time point, to acquire a state of the visualization.

The expression “state” should be understood to mean the current graphical rendition is created or influenced by the first operator by his own input and presented to him. The input by the first operator, for example, for determining the graphical objects, their arrangement and position relative to one another, their size and contents are therein also acquired as “state” (for example, input such as: open installation image . . . , open faceplate . . . and move to position . . . , open trend curve . . . for time range . . . and zoom factor . . . in position . . . , filter setting . . . for alarm indication, etc.).

Therein, for each graphical window, for each other object and suchlike, the actual size set by the first operator on the output of the operator station client can be acquired (for example, 200×100 pixels or 5%×5% of the output image).

Such a deposition of the state of a visualization in a memory store is often designated “persistence” of the state of the visualization. Expressed otherwise, in the deposited state of the visualization, there is a “persistence” of the visualization.

The visualization acquired and deposited in the first memory store preferably comprises a graphical reproduction of an installation image of the technical installation occurring at the first time point, a notification sequence display, a trend indication of a measurement value from the technical installation, an unsecured input by the operator in a text field and/or a setpoint value of a regulator set by the operator.

In addition, the first operator station client is configured to receive an information item relating to at least one second operator as the recipient for the deposited state of the visualization from the first operator and thereby to assign the state of the visualization deposited in the memory store to this second operator.

This assignment can occur, for example, because the deposition of the state of the visualization occurs in a storage region assigned to the second operator for transfers. Alternatively, the name of the second operator can also be stored together with the state of the visualization and thus the transferred visualization can be made to be locatable by the second operator.

The acquired state of the visualization can then be used by a second operator for the purpose of a later re-creation of the visualization on the first operator station client or another operator station client.

Therein, not only are re-usable templates exchanged between the operators, each being usable for their own installation visualization as in the prior art, but the actual visualizations of installation states present in the installation at a particular time point (for example, at the first time point or shortly before it) are exchanged. Operators can hereby support one another in the operation and observation where needed. This applies, in particular, for an often complex cause analysis for alarms and in the search for anomalies that must occur based on the actually existing state in the installation (for example, values of process variables, setpoint values, regulation variables, measurement values, alarms, operator inputs, etc.).

If, for example, an operator recognizes an anomaly in an installation image presented to him with further opened image windows, for example, notification sequences or trend indications and wishes to involve a further operator for assessment, then he can transfer his present visualization with all the opened image windows and settings to other operators, even if they are not currently available or are at an entirely different location. For this purpose, an operator can make the state of his present visualization persist and can share it with other operators, so that they can simulate exactly the transferred visualization in their respective environment (control room, in the field, mobile terminal, etc.). The other operators thereby receive all the information for a “reproduction” of the visualization of the first operator, which goes far beyond a pure screenshot. Based on the “reproduction”, the other operators can then adapt the visualization, i.e., the graphical objects, their arrangement and position relative to one another, their size and contents, to their own framework conditions (for example, size of the screen) or analysis task (for example, more exact detailed view for a particular graphical object).

Thus, an efficient and improved collaboration of a plurality of different operators can occur during the operation and observation of the technical installation.

The second operator can be a single person, but also a group of persons.

The control system is therein preferably configured, at the runtime of the technical installation at the instigation of the first operator, at a plurality of different first time points, to acquire, at each time point on the first operator station client, the respective current state of the visualization of an installation state in the technical installation and to deposit it in the memory store. The memory store is configured to store all the states of the visualization of the plurality of different first time points. The control system is therein configured to receive from the first operator, via the first operator station client, for each of the deposited states of the visualization, an information item relating to a second operator as the recipient for the deposited state of the visualization and thereby to assign the state of the visualization deposited in the memory store to this second operator. In other words, for a yet further improved operator collaboration, for example, for a yet further improved mutual support in alarm analyses and anomaly investigation, in the memory store, the states of a plurality of visualizations (or their persistences) can be simultaneously stored and made available to another operator.

Preferably, the control system is configured, on a request by the second operator at a second time point that is different from the first time point or the plurality of first different time points, to retrieve the state of the visualization from the first memory store or from a second memory store replicated with the first memory store and to bring a visualization currently being presented at the second time point to the second operator by one of the operator station clients into the state retrieved from the memory store. The second operator can thus himself determine the time point of the retrieval of the passed-on visualization.

Alternatively, the control system can be configured to automatically retrieve the state of the visualization from the first memory store or from a second memory store replicated with the first memory store and to bring the visualization currently being presented at the second time point to the second operator by one of the operator station clients to the state retrieved from the memory store, where the control system is preferably configured, before the updating, to generate a request to the second operator as to whether the updating should be performed. This is suitable, above all, for large multi-quadrant image displays in large control rooms.

For a simple selection of the recipient, the control system is advantageously configured to establish automatically operators registered in the control system at the runtime of the installation and to offer them to the first operator as recipients for the deposited state of the visualization for selection.

In accordance with a further advantageous embodiment, the operators are assigned access rights for visualizations in the control system and the control system is configured to offer to the first operator only those operators for selection as recipients who have an access right for the respective deposited visualization (or the objects contained therein). Thus, visualizations are passed on only to operators authorized therefor.

In accordance with a further advantageous embodiment, the control system is configured to establish states of the visualization deposited by the first operator in the memory store, to generate an information item for each of the established deposited states, and to represent this information item visually to the first operator. The first operator can thus always retain, on his currently used operator station client, an overview of the visualizations passed on by him.

The control system can also be configured to establish, for the second operator as recipient, states of the visualization deposited in the memory store, to generate an information item for each of the established deposited states, and to represent this information item visually to the second operator. The second operator can thus be notified, on a currently used operator station client, of visualizations passed on to him and can always retain an overview of the visualizations passed on to him.

For this purpose, the control system preferably has a user selection service, a first part of which is implemented on the at least one operator station server and a second part of which is implemented on the at least one operator station client, and which is configured to establish the states of visualizations deposited in the memory store, to generate an information item for each of the established deposited states, and to represent this information item visually to the operator.

In accordance with a still further advantageous embodiment, the operator station client of the second operator is configured to present simultaneously in a plurality of fields that are arranged beside and/or under one another, respective different visualizations and to receive, from the second operator, an information item regarding in which of the fields the visualization currently being presented there to the second operator by the operator station client is to be brought into the state retrieved from the memory store. Such a simultaneous representation of different visualizations in a plurality of fields is often designated “multiquadrant display” or “multiquadrant visualization” and is used, above all, in large image displays in control rooms. Particularly for this application case, the automated retrieval and presentation of the state of the visualization from the memory store as described above is also advantageous for the second operator.

The objects and advantages in accordance with the invention are also achieved by a method for operating a control system of a technical installation, in particular, a production or processing installation that comprises at least one operator station server and at least one operator station client, where the operator station server is configured to transfer visualization information to the operator station client and wherein the operator station client is configured to generate, based on the visualization information, a visualization for an operator of the technical installation. Therein, the method comprises:
a) at a first time point, receiving a request from a first operator (O1) to acquire a current state of the visualization (1), and an information item relating to at least one information item regarding at least one second operator (O2) as the recipient of the state of the visualization (1), and
b) depositing the state in a first memory store (58), where the deposited state is assigned to the second operator (O2),
where the acquisition of the state of the visualization comprises an acquisition of inputs by the first operator for generating the current state of the visualization and where the storage of the state comprises a storage of the acquired inputs.

The steps a) to d) can therein also be run through (performed sequentially) for a plurality of different first time points, where all the conditions of the visualization are deposited in the memory store.

In an advantageous embodiment of the method, upon a request by the second operator at a second time point that is different from the first time point or from the plurality of first different time points, the state of the visualization from the first memory store or from a second memory store replicated with the first memory store is retrieved and the visualization currently being presented at the second time point to the second operator by one of the operator station clients is brought into the state retrieved from the memory store.

In accordance with a further advantageous embodiment, the control system automatically retrieves the state of the visualization from the first memory store or from a second memory store replicated with the first memory store and brings the visualization currently being presented to the second operator by one of the operator station clients in the state retrieved from the memory store, where before the updating, the control system preferably generates a request to the second operator as to whether the updating should be performed.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention and further advantageous embodiments thereof, as per the features of the subclaims, will now be described in greater detail on the basis of exemplary embodiments illustrated in the figures, in which:

FIG. 1 shows an operator visualization for a first operator of a technical installation on a first operator station client in accordance with the invention;

FIG. 2 shows a process sequence for passing on an operator visualization of a first operator to a second operator in accordance with the invention;

FIG. 3 shows the visualization of FIG. 1 with a passing-on function;

FIG. 4 shows an operator visualization for a second operator of the technical installation on a second operator station client in accordance with the invention;

FIG. 5 shows the operator visualization of FIG. 4 with the embedded passed-on operator visualization of FIG. 1;

FIG. 6 shows an operator visualization for a second operator of the technical installation on a second operator station client with an automatic retrieval function for passed-on visualizations in accordance with the invention; and

FIG. 7 shows a schematic representation of a control system in accordance with the invention.

### DETAILED DESCRIPTION OF THE EXEMPLARY EMBODIMENTS

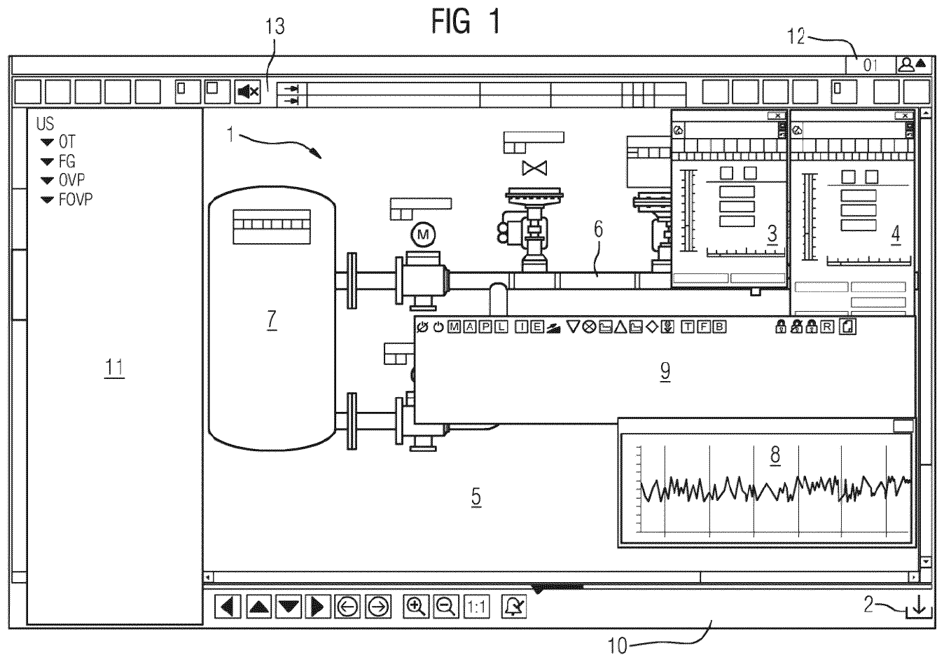

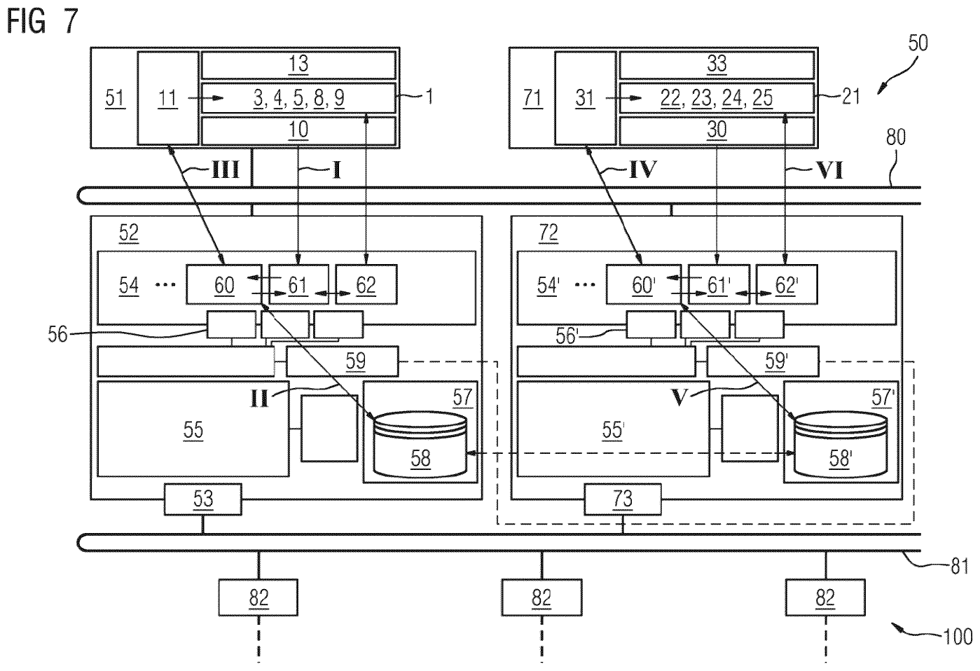

FIG. 1 shows a visualization which presents an operator station client (see FIG. 7) to a first operator O1 of a processing installation for operating and observing the processing installation.

The visualization comprises an installation visualization 1 as a central component. The visualization further comprises an operator operating field 10 in a lower region, an alarm field 13 in an upper region, and a user selection view 11 in a left-hand region. At top right in a field 12, the name of the current first operator is shown, in this case “O1”.

The installation visualization 1 comprises an installation image 5 with graphical representations of pipelines 6 and process objects 7, such as a tank or a boiler.

The installation visualization 1 further comprises two “faceplates” 3, 4, a trend curve 8 for a measurement value and an alarm output indicator 9.

The installation visualization 1 has thereby been generated by the first operator individually with regard to his current operating and observation tasks which, in turn, depend upon the current installation state. The installation visualization 1 therein visualizes an actually existing installation state in the installation at a particular time point, i.e., values of process variables, setpoint values, regulation variables, measurement values, alarms, flow rates, fill levels, operator inputs, etc., prevailing in the installation at a particular time point.

For example, for this purpose, the first operator has specifically opened a particular installation image 5. He has also opened, in a specific manner, the faceplates 3, 4 and positioned them with a particular size at a particular site in the installation image 5. In the installation image, he has also opened the trend curve 8 for a measurement value selected by him for a time region determined by him and a zoom factor and has positioned it with a size determined by him at a particular site in the installation image 5. A similar situation applies for the alarm output indicator 9.

It is also possible that the first operator has made inputs, such as new setpoint values for regulators, but without having adopted them actively in the control system up to the current time point, i.e., without having confirmed them. Further input can be, for example, filter settings for alarm notifications.

For the opening, selecting and positioning of these visualization objects, a number of inputs by the first operator are needed, which he can make via a graphical user interface and user dialogues, which the operator station client or the visualization 1 presented thereon enables for him. An individual creation of this type of a visualization is an example of a so-called user selection.

In the user selection view 11, information regarding user selections deposited by the first operator is visually presented to him for a later retrieval. Included therein are online trends OT, faceplate groups EG, operator view persistences OVP and operator view persistences FOVP passed on by him to other operators and received by other operators. Details regarding the operator view persistences OVP and the passed-on operator view persistences FOVP are explained below.

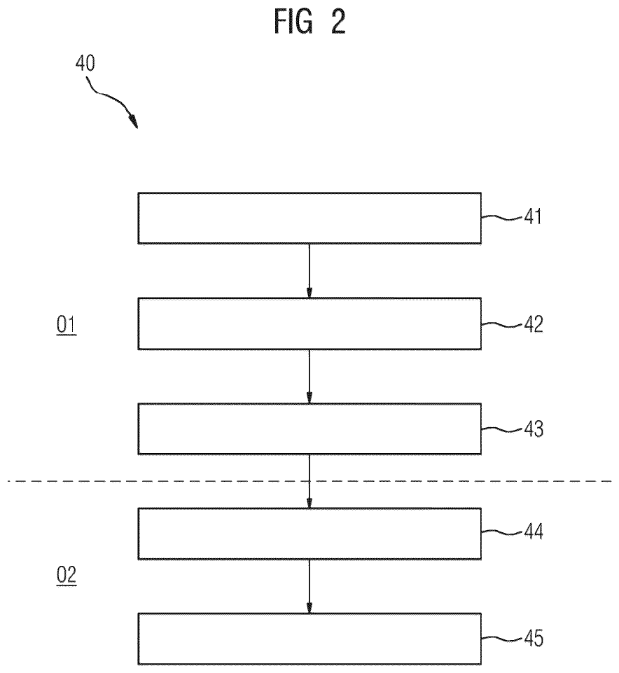

Firstly, with the aid of FIG. 2, a process sequence 40 in accordance with the invention for passing-on the visualization 1 of the operator O1 to a second operator O2 will be described.

In a first step 41, at a first time point, a request by the operator O1 to acquire the current state of the visualization 1 of the installation state is received. Now, the current state is acquired, where the inputs by the first operator O1 for generating the current state of the visualization 1 are also acquired as the “state” (for example, inputs such as: open installation image . . . , open faceplate . . . and move to position . . . , open trend curve . . . for time range . . . and zoom factor . . . in position . . . , filter setting . . . for alarm indication, etc.). The acquired state is designated “persistence” below.

In a second step 42 of the method, this state is deposited in a memory store. In this process, the acquired inputs of the operator O1 are thus also deposited.

In a third step 43, an information item from the operator O1 to the operator O2 as recipient for the deposited state of the visualization 1 is received and the state of the visualization deposited in the memory store is assigned to the operator O2.

Steps 41 to 43 can therein also be run through for a plurality of different first time points, where all the states of the visualization that are each current are deposited in the memory store and assigned to the operator O2 or other operators as recipients.

In a fourth step 44, either upon a request by the operator O2 at a second time point that is different from the first time point or from the plurality of first different time points, or automatically by the control system, the state of the visualization 1 is retrieved from the first memory store or from a second memory store replicated with the first memory store.

In a fifth step 45, the visualization currently presented to the operator O2 by one of the operator station clients is brought into the state retrieved from the memory store. The operator O2 now receives the visualization 1 passed on to him by the operator O1 presented to him by his current operator station client.

In the case of the exemplary embodiment of FIG. 1, for steps 41 and 42, a selection field 2 is provided in the right corner of the operator operating field 10 of FIG. 1. With the selection of the selection field 2 (symbolized by a downwardly pointing arrow), the operator O1 can manually trigger an “ad hoc” persistence of the installation visualization 1. Therein, the state of the visualization 1 is acquired and deposited in a memory store of an operator station server connected to the operator station client (for technical details thereto, see FIG. 7). Therein, the inputs by the first operator O1, described in the introduction, for generating the current state of the visualization 1 are also acquired and stored.

A type T of the persistence, the name O of the operator who has stored the persistence and the date and time D are automatically stored. In order to be able to distinguish better between different operator view persistences, the operator O1 can optionally also insert a comment C when making the depositions.

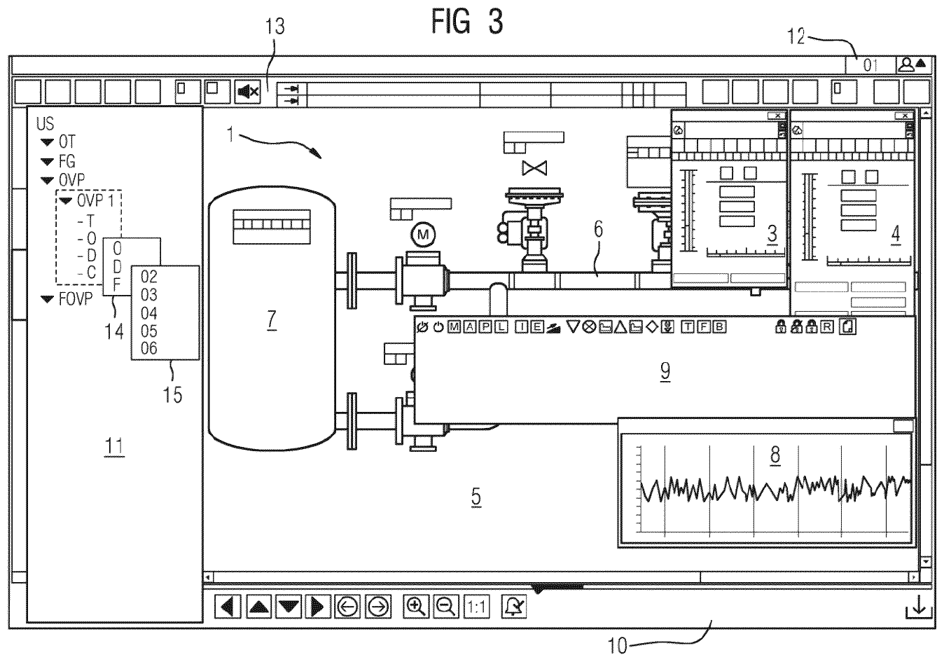

As FIG. 3 shows, the persistence of the state of the visualization 1 created by the operator O1 is presented visually to the operator O1 in the user selection view 11 under the deposited operator view persistences OVP as operator view persistence OVP1 together with the type T, name O of the operator, the date/time D and the comment C.

If, at further time points, the operator O1 has generated and stored further operator view persistences, these are displayed to him visually under the operator view persistence OVP1 together with the type T, name O of the operator, the date/time D and the comment C.

By way of a selection window 14, options are now offered to the operator O1 for an opening O, a deletion D and a passing-on F of the deposited persistence OVP1.

On selection of the option O for opening, the operator O1 can open the deposited persistence OVP1, i.e., retrieve it from the memory store and cause it to be displayed on his operator station client.

On selection of the option D for deletion, the deposited persistence OVP1 is deleted in the memory store.

For step 43 of the process sequence 40 of FIG. 2, the option F for passing-on of the deposited persistence OVP1 is present. On selection of the option F for passing-on, a selection window 15 opens for the operator O1 in which all the further operators O2-O6 registered in the control system who have an access right for the persistence OVP1 are displayed.

For this purpose, the control system is configured, at the runtime of the installation, to establish automatically operators registered in the control system and to offer them to the operator O1 as recipients for the deposited persistence OVP1 for selection. The operators are therein assigned access rights in the control system for visualizations and the control system is configured to offer to the operator O1 only those operators as recipients for selection who have an access right for the persistence OVP1 (or the objects contained therein). To this end, for example, a user selection service of the control system can be utilized (see FIG. 7), which automatically creates a user selection for each user who registers in the control system at runtime.

The recipients can be individuals or groups of persons. Apart from operators, other persons or groups of persons, such as maintenance personnel, can also be recipients of the operator view persistence OVP1.

In the example of FIG. 3, the operator O1 selects the operator O2 as the recipient of the operator view persistence OVP1.

The operator view persistence OVP 1 is thereby assigned to the operator O2 as the recipient, such as by depositing the persistence (that is, the state of the visualization) in a region of the memory store assigned to the operator O2 for passing on persistences or by depositing an information item in the memory store via the operator O2 as the recipient. The deposited persistence OVP1 is thus made discoverable for the recipient O2.

If, in the control system, a plurality of operator station servers are present, then the memory store content is replicated on the server side, i.e., distributed across all the servers. The memory stores of the servers are then replicated. An operator or an operator station client then has, notwithstanding at which server he registers, access to the passed-on persistences.

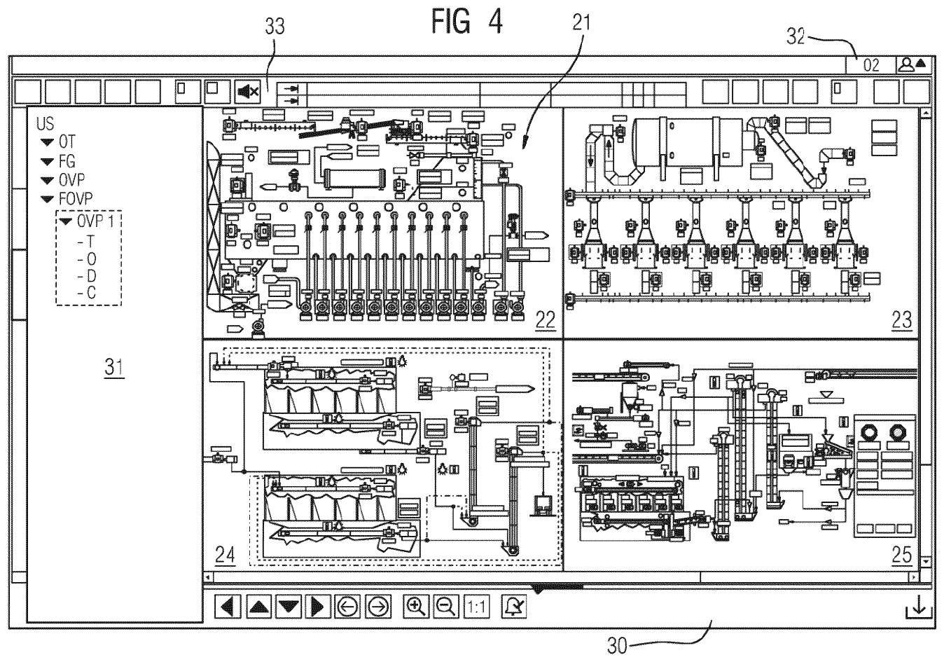

FIG. 4 shows a visualization that presents an operator station client (see FIG. 7) to the operator O2 of a processing installation for operating and observing the processing installation. In the normal case, the operator station client is a different operator station client than the operator station client used by the operator O1 for the acquisition of his visualization. In principle, however, it can also be the same operator station client, for example, in the case of an operator change in the case of shift operation.

The visualization comprises an installation visualization 21 as a central component. The visualization further comprises an operator operating field 30 in a lower region, an alarm field 33 in an upper region, and a user selection view 31 in a left-hand region. At top right in a field 32, the name of the current operator is shown, in this case “O2”.

The installation visualization 21 is configured as a multifield and/or multiquadrant visualization, here as a four-quadrant visualization with four quadrants. In each of the four quadrants, different (partial) installation visualizations 22, 23, 24, 25 are presented.

In the user selection view 31, information regarding user selections deposited by the operator O2 is visually presented to him. Included therein are online trends OT, faceplate groups FG and operator view persistences OVP. In addition, operator view persistences FOVP passed on by him to other operators and passed on to him (or received) by other operators are visually represented.

In the exemplary embodiment, the operator O1 has passed on the operator view persistence OVP1 to the operator O2, for which reason it is now visually represented to the operator O2 under the passed-on operator view persistences FOVP. The operator O2 can now open and evaluate the operator view persistence OVP1 at any desired time point.

If further operator view persistences have been passed on to the operator O2, then these are represented visually below the operator view persistence OVP1.

In order that, even with the user selection window closed for passed-on operator view persistences FOVP, the operator O2 can notice operating view persistences passed on to him, he is notified accordingly via the selector module surface for opening the user selection (for example, blinking red).

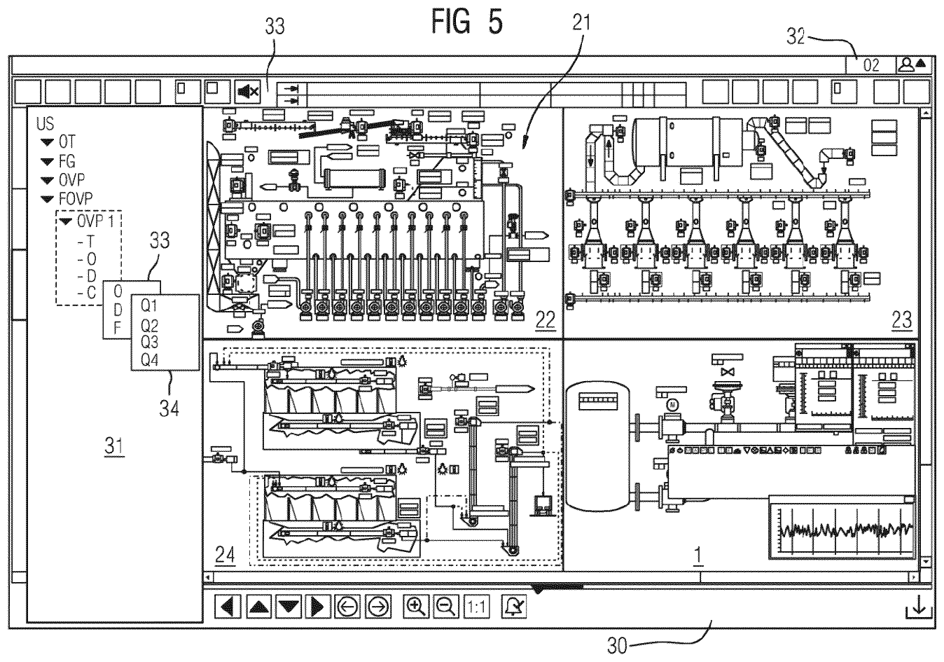

As shown by FIG. 5, via a selection window 33, options are now offered to the operator O2 for an opening O, a deletion D and a passing-on F of the persistence OVP1 passed on to him.

On selection of the option O for opening, the operator O2 can open the passed-on persistence OVP1, i.e., retrieve it from the memory store and bring the visualization currently presented on his operator station client into the state of the deposited persistence OVP1.

On selection of the option D for deletion, the persistence OVP1 passed on to him is deleted in the memory store.

With the option F, he can pass on to other operators the persistence OVP1 that has been passed on to him.

On selection of the option O for opening, the operator O1 is offered a selection via a further selection field 34 as to in which of the four quadrants Q1, Q2, Q3, Q4 of the four-quadrant visualization, the persistence OVP1 is to be displayed.

In the case of FIG. 5, it is assumed that the operator O2 makes the decision for the fourth quadrant Q4. Therefore, the operator view persistence OVP1 is now retrieved from the memory store and the installation visualization 25 previously displayed in quadrant Q4 is now replaced by the installation visualization 1 based on the operator view persistence OVP1.

The operator view persistence OVP1 displays not only a screenshot, but the inputs for creating the visualization are also taken into account. As a result, a “reproduction” of the visualization 1 of the operator O1 can be provided to the operator O2. Based on the “reproduction”, if required, the operator O2 can adapt the visualization presented to him, i.e., the graphical objects, their arrangement and position relative to one another, their size and contents, to his own framework conditions (for example, a size of the screen) or his analysis tasks (for example, more exact detailed view for a particular graphical object).

Thus, an efficient collaboration of a plurality of different operators can occur during the operation and observation of the technical installation.

If the operator O2 has queries, proceeding from the passed-on persistence OVP1, then a new operator view persistence can be created by the operator O2, commented upon and sent to the operator O1.

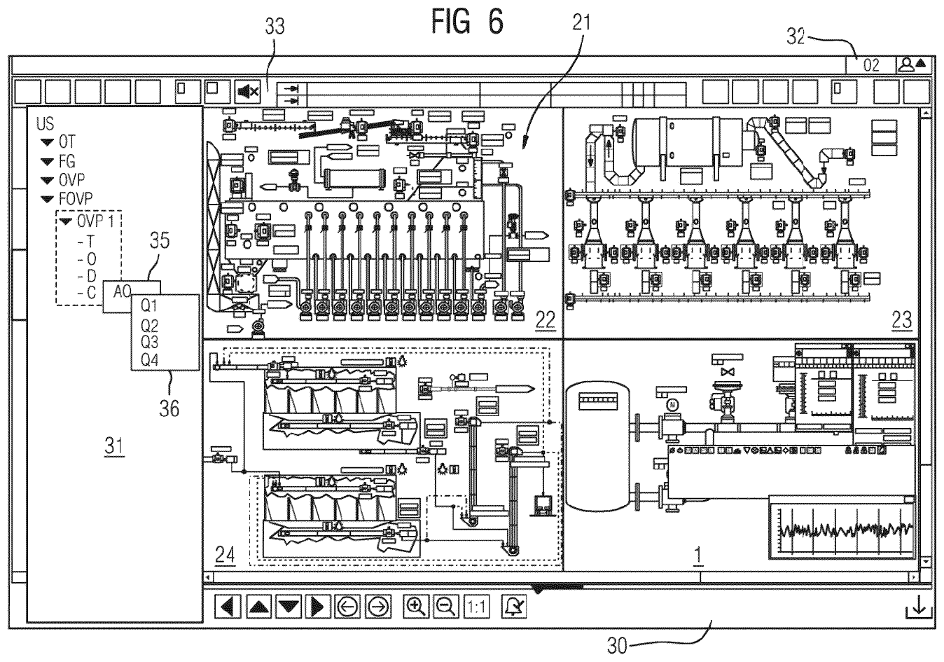

Alternatively, as described in relation to FIG. 6, the operator O2 can determine that operator view persistences passed on to him are called up automatically from the memory store and a visualization presented in one quadrant of the four-quadrant visualization is brought into the state retrieved from the memory store.

Herein, via a selection window 35, an option AO for an automatic opening of the passed-on operator view persistences can be selected for the operator O2. In a subsequent selection window 36, a selection is offered to him over in which of the four quadrants Q1, Q2, Q3, Q4 of the four-quadrant visualization, the operator view persistence is to be displayed automatically.

In the case of FIG. 6, it is assumed that the operator O2 decides for the four quadrants Q4.

The operator view persistence OVP1 is therefore automatically opened promptly after its passing-on to the operator O2, i.e., the operator view persistence OVP1 is retrieved automatically from the memory store and the previously current installation visualization 25 displayed in quadrant O4 is replaced by the installation visualization 1 based on the operator view persistence OVP1.

FIG. 7 shows schematically a control system 50 in accordance with the invention for operating and observing a processing installation 100. The control system 50 comprises the aforementioned operator station clients 51, 71 and the operator station servers 52, 72. The operator station servers 52, 72 and the operator station clients 51, 71 are connected to one another via a terminal bus 80 and are optionally connected to further components (not shown) of the control system 50. The operator station client 51 is, for example, an operator individual workplace and the operator station client 71 is a four-quadrant large display in a control room.

For the purpose of operating and observing via one of the operator station clients 51, 71, an operator can access the operator station servers 52, 72 via the terminal bus 80. For example, the operator O1 works on the operator station client 51 and the operator O2 works on the operator station client 71. The terminal bus 80 can be configured, without being restricted thereto, for example, as an industrial ethernet.

The operator station servers 52, 72 each have a device interface 53 or 73, which is connected to an installation bus 81. Via this device interface 53 or 73, the operator station server 52, 72 can communicate with automation devices 82 and with optionally existing further components of the processing installation 100, such as peripheral devices (not shown). The installation bus 81 can be configured, without being restricted thereto, for example, as an industrial ethernet.

Implemented on the operator station servers 52, 72 are (inter alia) a visualization service 54 or 54′, a process map 55 or 55′, a distribution service 59 or 59′, a user selection service 60 or 60′ and a user selection manager 57 or 57′ with a memory store 58 or 58′.

The visualization service 54, 54′ initiates a transfer of visualization information to the operator station client 51 or 71. The operator station client 51 or 71 is configured to represent a visualization, i.e., a graphical presentation, in particular of installation images, for operating and observing the processing installation 100. The visualization service 54, 54′ comprises a screen object model 62 or 62′ in which the state of the visualization 1 or 21 is stored, i.e., including all the inputs of the operator O1 or O2 for generating the visualization.

Deposited in the process map 55 or 55′ is a screenshot of the (signal) states of devices and/or applications connected to the operator station server 52 or 72.

An alarm service 56 or 56′can read out alarm notifications from the process map 55 or 55′ and generate, for example, a graphical aggregation of the alarm notifications that the operator station client 51 or 71 can represent.

The user selection service 60 or 60′ has access to the memory store 58 or 58′ of the operator station server 52 or 72. User profiles and personal settings of operators/users of the processing installation can be deposited therein. These can also be accessible to further operators/users. The user selection service 60 or 60′ has access to the user selection region 11 or 31 in which, as explained referring to FIGS. 1 to 6, information regarding the operator view persistences acquired from an operator and deposited in the memory store 58 or 58′, i.e., states OVP of visualizations, is set out visually.

On the operator station client 51, as a central element, the visualization 1 is presented with the installation image 5, the faceplates 3, 4 of the trend progress indicator 8 and of the notification sequence indicator 9. Furthermore, on the operator station client 51, the user selection view 11, the operator input field 10 and the alarm field 13 are also presented.

In a corresponding manner, on the operator station client 71 configured as a four-quadrant large display, as a central element, the four-quadrant display 21 is presented with the installation visualizations 22, 23, 24, 25. Furthermore, on the operator station client 71, a user selection view 31, an operator input field 30 and an alarm field 33 are presented.

The memory stores 58, 58′ are therein replicated with one another with the aid of the distribution service 59 or 59′, i.e., the entire quantity of the stored data is continuously matched in the memory stores 58, 58′ by the distribution service 59 or 59′ and is therefore kept identical in content.

An operator or operator station client then has, notwithstanding at which operator station server he registers himself, access to all the persistences deposited by him or passed on to him.

A state of the installation visualization 1 on the operator station client 51 is acquired and deposited in the memory store 58 as follows:

Step I: The operator O1 triggers manually, via the selection field 2 (see FIG. 1), the acquisition of the state of the visualization (persistence) of an installation state at a particular (first) time point via the operator station client 51. This trigger is acquired by a control component 61 of the operator station server 52.

Step II: The control component 61 acquires a visualization state defined via a screen object model 62 and transfers it to the user selection service 60 that automatically stores it with additional data, such as type, name of operator, date/time and possibly a comment by the operator, in a region of the memory store 58 assigned to the operator O1 for a depositing of persistences. With the user selection manager 57, using the distribution service 59, a replication of the stored persistence in the memory store 58′ occurs automatically. An information item regarding the stored persistence OVP1 is set out visually for the operator O1 in the user selection view 11 in the category of deposited operator view persistences OVP.

Step III: The operator O1 manually triggers a passing-on of the deposited persistence OVP1 to the recipient O2 via the selection windows 13, 14 in the user selection view 11 (see also FIG. 3). A user selection is generated for each operator registered in the control system. As result, the user selection service 60′ can establish which operators are registered in the control system and can offer only registered operators to the operator O1 for selection. The user selection service 60′ can therein also offer only operators for selection who have an authorization for access to the persistence OVP1.

The user selection service 60 now assigns the deposited persistence OVP1 to the operator 2 as recipient because it deposits a copy of the persistence OVP1 in a region of the memory store 58 assigned to the operator O2 for the passing on of persistences. With the user selection manager 57, using the distribution service 59, a replication of the passed-on persistence into the memory store 58′ takes place automatically. An information item regarding the passed-on persistence OVP1 is set out visually for the operator O2 in the user selection view 31 in the category of passed-on operator view persistences FOVP (see also FIG. 4).

Step IV: If the operator O2 wishes to retrieve the state of the visualization of the passed-on persistence OVP1 and to have it presented on the operator station client 72, via the user selection region 31, then he triggers the user selection service 60′ and selects the option “O” in the window 33 for the persistence OVP1 for opening. Alternatively, the operator O2 can also specify the user selection service 60′ to open the persistence OVP1 automatically (see FIG. 6). The operator station client 71 is a four-quadrant display. As a result, in the user selection view 31 of the user selection service 60′, another information item is called up by the operator O1 to the quadrant in which the passed-on persistence OVP1 is to be displayed (see FIGS. 5 and 6).

Step V: The user selection service 60′ reads the persistence OVP1 from the memory store 58′ and from it generates a screen object model 62′ by means of the control component 61′.

Step VI: Based on the screen object model 62′, the visualization service 54′ now causes the passed-on state of the visualization 1 to be displayed on the operator station client 71, i.e., the visualization 1 is reproduced there. In the event of an automatic opening of the persistence OVP1, before the display, a request can be made to the operator O2 as to whether the display should occur.

Thus, with the system and method of the invention, an efficient collaboration of a plurality of different operators can occur in the operation and observation of the technical installation. Visualizations of installation states can actually be exchanged in the installation between operators at a particular time point (for example, at the first time point or shortly before it). Operators can hereby support one another in the operation and observation where needed. This particularly applies in the often complex causal analysis for alarms and in the search for anomalies that must be performed based on the actual state prevailing in the installation (for example, values of process variables, setpoint values, regulation variables, measurement values, alarms, and/or operator inputs).

If, for example, the operator O1 notices an anomaly in an installation image presented to him with further opened image windows, for example, notification sequences or trend indications, and wishes to involve the operator O2 for assessment, then he can transfer his present visualization with all the opened image windows and settings to the operator O2, even if he is not currently available or is at an entirely different location. For this purpose, the operator O1 can make the state of his present visualization persist and can share it with the operator O2, so that the operator O2 can follow exactly the transferred visualization in his respective environment (e.g., control room, in the field, or mobile terminal).

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-17. (canceled)

18. A control system for a technical installation, comprising:
at least one operator station server; and
at least one operator station client connected to the operator station server;
wherein the operator station server is configured to transfer visualization information to the operator station client;
wherein the operator station client is configured to generate a visualization for an operator for operation and observation of the technical installation based on the visualization information;
wherein the control system is configured, during runtime of the technical installation, upon instigation of a first operator for the operation and observation of the technical installation, at at least one first time point, to acquire a current state of the visualization of an installation state which is generated at this time point by a first of the operator station clients and to deposit said current state of the visualization in a, non-volatile, first memory store;
wherein the acquisition of the state of the visualization comprises an acquisition of inputs by the first operator for generating the current state of the visualization and wherein the deposition of the state comprises a deposition of the acquired inputs; and
wherein the control system is further configured to receive from the first operator, via the first operator station client, an information item relating to at least one second operator for the operation and observation of the technical installation as a recipient for the deposited state of the visualization and to assign the state of the visualization deposited in the first memory store to this second operator.

19. The control system as claimed in claim 18, wherein the control system is further configured, at the runtime of the technical installation at the instigation of the first operator, at a plurality of different first time points, to acquire, at each time point on the first operator station client, a respective current state of the visualization of an installation state in the technical installation and to deposit said respective current state of the visualization in the memory store;
wherein the memory store is configured to store all states of the visualization of the plurality of different first time points; and
wherein the control system is further configured to receive from the first operator, via the first operator station client, for each of the deposited states of the visualization, an information item relating to a second operator as the recipient of the deposited state of the visualization and to assign the state of the visualization deposited in the memory store to this second operator.

20. The control system as claimed in claim 18, wherein the control system is further configured, on a request by the second operator at a second time point which is different from the first time point or from the plurality of first different time points, to retrieve the state of the visualization from the first memory store or from a second memory store replicated with the first memory store and to bring a visualization currently being presented at the second time point to the second operator by one of the operator station clients to the state retrieved from the memory store.

21. The control system as claimed in claim 18, wherein the control system is further configured to retrieve automatically the state of the visualization from the first memory store or from a second memory store replicated with the first memory store and to bring the visualization currently being presented at the second time point to the second operator by one of the operator station clients to the state retrieved from the memory store; and wherein the control system is further configured, before the updating, to generate a request to the second operator as to whether the updating should be performed.

22. The control system as claimed in claim 19, wherein the control system is further configured to retrieve automatically the state of the visualization from the first memory store or from a second memory store replicated with the first memory store and to bring the visualization currently being presented at the second time point to the second operator by one of the operator station clients to the state retrieved from the memory store; and wherein the control system is further configured, before the updating, to generate a request to the second operator as to whether the updating should be performed.

23. The control system as claimed in claim 18, wherein the state of the visualization comprises at least one of a graphical reproduction, occurring at the first time point, of an installation image of the technical installation, a trend indication of a measurement value from the technical installation, a faceplate, a notification sequence indication, an unsecured input by the first operator in a text field and a setpoint value of a regulator set by the first operator.

24. The control system as claimed in claim 18, wherein the control system is further configured to automatically establish operators registered in the control system at the runtime of the installation and to offer them to the first operator as recipients for the deposited state of the visualization for selection.

25. The control system as claimed in claim 24, wherein the operators are assigned access rights for visualizations and the control system is further configured to offer to the first operator only those operators as recipients for selection who have an access right for the respective deposited visualization.

26. The control system as claimed in claim 18, wherein the control system is further configured to establish states of visualizations deposited by the first operator in the memory store, to generate an information item for each of the established deposited states, and to represent this information item visually to the first operator.

27. The control system as claimed in claim 18, wherein the control system is further configured to establish states of visualizations deposited in the memory store for the second operator as recipient, to generate an information item for each of the established deposited states, and to represent this information item visually to the second operator.

28. The control system as claimed in claim 18, wherein the control system includes a user selection service, a first part of which is implemented on the at least one operator station server and a second part of which is implemented on the at least one operator station client, and where the control system is further configured to establish the states deposited in the memory store of visualizations, to generate an information item for each of the established deposited states, and to represent this information item visually to the operator.

29. The control system as claimed in claim 18, wherein the first memory store is a non-volatile storage region of the operator station server.

30. The control system as claimed in claim 18, wherein the control system comprises a plurality of operator station servers, each operator station server having a memory store for depositing states of visualizations; and wherein the memory stores are replicated with one another.

31. The control system as claimed in claim 18, wherein the at least one operator station client is configured to present, in a plurality of fields which are arranged at least one of beside and under one another, respectively different visualizations and to receive, from the second operator, an information item regarding in which of the fields a visualization currently being presented there to the second operator by the operator station client is to be brought into the state retrieved from the memory store.

32. The control system as claimed in claim 18, wherein the technical installation comprises a production or processing installation.

33. A method for operating a control system of a technical installation which comprises at least one operator station server and at least one operator station client, the operator station server being configured to transfer visualization information to the operator station client and the operator station client being configured to generate a visualization for an operator for operation and observation of the technical installation of the technical installation based on the visualization information, the method comprising:
a) receiving, at a first time point, a request from a first operator for the operation and observation of the technical installation to acquire a current state of the visualization of an installation state, and an information item regarding at least one second operator for the operation and observation of the technical installation as the recipient of the state of the visualization; and
b) depositing the acquired state in a first memory store, the deposited state being assigned to the second operator;
wherein the acquisition of the state of the visualization comprises an acquisition of inputs by the first operator for generating the current state of the visualization; and
wherein the deposition of the state comprises a deposition of the acquired inputs.

34. The method as claimed in claim 33, wherein steps a) to d) are executed ion sequence for a plurality of different first time points; and wherein all conditions of the visualization are deposited in the memory store.

35. The method as claimed in claim 33, wherein, upon a request by the second operator at a second time point which is different from the first time point or from the plurality of first different time points, the state of the visualization is retrieved from the first memory store or from a second memory store replicated with the first memory store and the visualization currently being presented at the second time point to the second operator by one of the operator station clients is brought into the state retrieved from the memory store.

36. The method as claimed in claim 34, wherein, upon a request by the second operator at a second time point which is different from the first time point or from the plurality of first different time points, the state of the visualization is retrieved from the first memory store or from a second memory store replicated with the first memory store and the visualization currently being presented at the second time point to the second operator by one of the operator station clients is brought into the state retrieved from the memory store.

37. The method as claimed in claim 33, wherein the control system automatically retrieves the state of the visualization from the first memory store or from a second memory store replicated with the first memory store and brings the visualization currently being presented to the second operator by one of the operator station clients into the state retrieved from the memory store; and wherein the control system generates a request to the second operator as to whether the updating should be performed before the updating.

38. The method as claimed in claim 34, wherein the control system automatically retrieves the state of the visualization from the first memory store or from a second memory store replicated with the first memory store and brings the visualization currently being presented to the second operator by one of the operator station clients into the state retrieved from the memory store; and wherein the control system generates a request to the second operator as to whether the updating should be performed before the updating.

39. The method as claimed in claim 33, wherein the technical installation comprises a production or processing installation.
